(19) United States
(12) Patent Application Publication
(10) Pub. No.: US 2015/0330707 A1
(43) Pub. Date: Nov. 19, 2015

(54) SUPERHEATING OF AN EXPORT GAS USED IN A REDUCTION PROCESS, IN ORDER TO BALANCE OUT AMOUNT FLUCTUATIONS, AND DEVICE

(71) Applicant: PRIMETALS TECHNOLOGIES AUSTRIA GMBH, Linz (AT)

(72) Inventors: Robert MILLNER, Loosdorf (AT); Gerald ROSENFELLNER, Ertl (AT)

(21) Appl. No.: 14/652,511

(22) PCT Filed: Oct. 10, 2013
(86) PCT No.: PCT/EP2013/071250

§ 371 Date: Jun. 16, 2015

(30) Foreign Application Priority Data
Dec. 21, 2012 (EP) 12198903.2

(51) Int. Cl. F27D 17/00; C21B 13/14; C21B 5/00

(52) U.S. Cl. CPC F27D 17/004; C21B 5/00; C21B 13/14; F27D 17/008

(57) ABSTRACT

A method and a device for balancing out amount fluctuations while simultaneously increasing the temperature of an export gas (2) used in a reduction process (1). A first partial amount (3) of a recycling gas (4) is cooled in at least one recycling-gas cooler (5) to form a cold recycling gas (6) and the cold recycling gas (6) is fed to the export gas (2) in a pressure-controlled and/or amount-controlled manner in order to balance out amount fluctuations of the export gas (2). A second partial amount of the recycling gas (4) is fed to the export gas (2) as hot recycling gas (7) having a higher temperature than the cold recycling gas (6). Then an export gas mixture (8) of the cold recycling gas (6) and the hot recycling gas (7) is introduced into the reduction process (1), wherein the temperature of the export gas mixture (8) is higher than the temperature of the export gas (2). The temperature of the export gas (2) or of the export gas mixture (8) is set in such a way that temperature is higher than the dew point or dew point temperature of the export gas mixture.

### TECHNICAL FIELD

The invention relates to a method for balancing out amount fluctuations while simultaneously increasing the temperature of an export gas used in a reduction process. In this case, a first partial amount of a recycle gas is cooled in at least one recycle gas cooler to form a cold recycle gas. The cold recycle gas is added to the export gas in a pressure-controlled and/or amount-controlled manner, in order to balance out amount fluctuations of the export gas.

The invention further relates to a device for performing the method according to the invention.

### PRIOR ART

Use of an export gas in a reduction process is known from the prior art. The export gas in this case comes from an external gas source such as a plant for producing pig iron and/or a coal gasification plant and/or a coking plant, for example. In this case, the reduction process also includes preparation of the export gas to form a reduction gas, e.g. compression of the export gas in an export gas compressor and elimination of the CO₂ from the compressed export gas, before the reduction gas is supplied to a reduction unit for the reduction of metal oxides.

The export gas is often subject to amount fluctuations. This may result in disadvantageous operating states in the reduction process, said states being resolved by means of measures that are known from the prior art, e.g. adding a variable amount of a gas stream to the export gas in order to balance out the amount fluctuations.

In this case, it is disadvantageous that the export gas often has a temperature which is at or just marginally above the dew point of the export gas. If such an export gas is introduced into the export gas compressor, for example, there is a danger that wet/dry transitions may occur as a result of falling below the dew point of the export gas, particularly at inlet guides and impellers of the export gas compressor, and/or that residues may accumulate at the inlet guides and impellers of the export gas compressor due to condensation/sublimation of polyaromatic hydrocarbons in the export gas.

Heat exchangers which may be present and into which such an export gas is introduced may likewise be affected by such accumulated residues.

### SUMMARY OF THE INVENTION

### Technical Problem

The object of the present invention is to provide a method and a device by means of which it is possible to overcome the disadvantages that are known from the prior art.

### Technical Solution

This object is achieved by a method for balancing out amount fluctuations while simultaneously increasing the temperature of an export gas which is used in a reduction process, said method comprising method steps as follows:
cooling a first partial amount of a recycle gas in at least one recycle gas cooler to form a cold recycle gas, and
adding the cold recycle gas to the export gas in a pressure-controlled and/or amount-controlled manner in order to balance out amount fluctuations of the export gas (31),
   wherein a second partial amount of the recycle gas is inventively added to the export gas in a pressure-controlled and/or amount-controlled manner as a hot recycle gas having a higher temperature than the cold recycle gas, after which an export gas mixture comprising the cold recycle gas and the hot recycle gas is introduced into the reduction process, and wherein the temperature of the export gas mixture is higher than the temperature of the export gas.

An export gas is understood to be a gas which comes from an external gas source. An external gas source is a plant for producing pig iron and/or a coal gasification plant and/or a coking plant, for example. The export gas may also include e.g. crucible gas or blast-furnace gas from the gas network of a steelworks or an integrated iron and steelworks.

The method comprises the cooling of the first partial amount of the recycle gas in the recycle gas cooler. The cooled recycle gas is subsequently referred to as cold recycle gas. The cold recycle gas is added to the export gas in a pressure-controlled and/or amount-controlled manner, in order to balance out the amount fluctuations of the export gas. This pressure-controlled and/or amount controlled supply is effected by means of a recycle gas compressor, for example. According to the invention, the second partial amount of the recycle gas, having a higher temperature than the cold recycle gas, is added to the export gas in a pressure-controlled and/or amount-controlled manner. For clarity, this second partial amount of the recycle gas is subsequently referred to as hot recycle gas. The cold recycle gas and the hot recycle gas each correspond to different partial amounts of the same recycle gas. The cold recycle gas and the hot recycle gas are added to the export gas, the order in which these two gases are added to the export gas being arbitrary. The hot recycle gas may be added to the export gas first, followed by the cold recycle gas, or the cold recycle gas may be added before the hot recycle gas. In the first variant, the export gas already contains the hot recycle gas before the cold recycle gas is added, whereas in the second variant the export gas already contains the cold recycle gas before the hot recycle gas is added.

The invention also comprises the addition of the cold recycle gas and the hot recycle gas to the export gas as a mixture consisting of the cold recycle gas and the hot recycle gas. In this case, the hot recycle gas is mixed with the cold recycle gas first, and the mixture is then added to the export gas. The export gas contains both the cold recycle gas and the hot recycle gas after addition of the mixture.

The addition of the hot recycle gas and the cold recycle gas to the export gas as a mixture has the advantage that only a single line is required for adding the mixture to the export gas, and therefore a very compact structural format is possible.

The export gas contains at least one of the following gas components: carbon monoxide (CO), carbon dioxide (CO₂), hydrogen (H₂) , nitrogen (N₂) , methane (CH₄) , water vapor (H₂O). The recycle gas contains at least one of the following gas components: carbon monoxide (CO), carbon dioxide (CO₂), hydrogen (H₂), nitrogen (N₂), methane (CH₄), water vapor, and can come from any desired gas source.

In this context, a reduction process is understood to signify not only a reduction of metal oxides by means of a reduction gas in a reduction unit, but also all of the method steps that are required to prepare the export gas mixture in order to form the reduction gas.

The export gas containing the cold recycle gas and the hot recycle gas is subsequently referred to as an export gas mixture, which is introduced into the reduction process. The temperature of the hot recycle gas is higher than the temperature of the export gas before the addition of the hot recycle gas and the cold recycle gas to the export gas. Moreover, the temperature of the hot recycle gas is higher than the temperature of the cold recycle gas.

The temperature of the export gas mixture is therefore higher than the temperature of the export gas before the addition of the cold recycle gas and the hot recycle gas.

As a result of adding the hot recycle gas to the export gas, the sensible energy of the hot recycle gas is used to increase the temperature of the export gas. The temperature of the export gas or of the export gas mixture is therefore so adjusted as to be higher than its dew point or its dew point temperature. This operation is known as superheating of the export gas or the export gas mixture. One advantageous effect of this superheating is to avoid wet/dry transitions due to condensation/evaporation of water as a result of falling below the dew point of the export gas mixture, and to prevent an accumulation of residues at inlet guides and/or impellers of the export gas compressor due to condensation/sublimation of polyaromatic hydrocarbons in association with dust particles which may be present in the export gas or in the export gas mixture and/or in the recycle gas. The measures according to the invention also minimize the danger of stress crack corrosion at the impellers of the export gas compressor.

The cold recycle gas preferably has essentially the same temperature as the export gas.

The expression “essentially the same temperature” is understood to mean that the temperatures of the cold recycle gas and the export gas differ by no more than 40° C., preferably by no more than 20° C., and most preferably by no more than 10° C.

In a preferred embodiment variant of the inventive method, a reduction gas obtained from the export gas mixture is introduced into a reduction unit for the reduction of metal oxides, after which the reduction gas is withdrawn from the reduction unit as a top gas after at least partial reduction of the metal oxides, wherein the reduction gas is obtained by method steps as follows:
compressing the export gas mixture in at least one export gas compressor to form a process gas,
optionally cooling the process gas in a process gas cooler and eliminating CO₂ and/or H₂O from the process gas in a CO₂ eliminating device while obtaining the reduction gas, and
heating the reduction gas in a reduction gas heating device,
   and wherein a first partial amount of the top gas, which is preferably dedusted and/or preferably cooled, is used as the recycle gas, possibly after compression.

The elimination of CO₂ from the process gas involves e.g. the removal of CO₂ from the process gas or the conversion of CO₂ into CO, e.g. by means of a reformer as disclosed in the prior art.

The reduction unit is e.g. a blast furnace or a direct reduction unit which is designed on the basis of a fixed bed, fluidized bed or moving bed. Of course, provision may also be made for a plurality of reduction units into which the reduction gas is introduced.

A reduction gas is understood to be a gas which is suitable for reducing metal oxides, particularly iron ores or iron oxides, at least partially to form metals, particularly iron, e.g. a gas which has carbon monoxide and/or hydrogen as its main component.

The metal oxides which are reduced in the reduction unit by means of the reduction gas are referred to as DRI or direct reduced iron. If the reduction unit is designed as a fluidized-bed reactor, the DRI is then briquetted to form e.g. HBI (hot briquetted iron) in order that it can then be reused in an iron or steel production process.

After the metal oxides have been reduced by means of the reduction gas, the reduction gas which is at least partially converted in this way is withdrawn from the reduction unit as top gas. The first partial amount of the top gas, which is preferably dedusted and/or cooled in an apparatus for dust removal and/or cooling, is used as the recycle gas, possibly after compression.

The export gas mixture is compressed in the export gas compressor to form the process gas. The elimination of the CO₂ from the process gas is preferably effected by means of pressure-swing adsorption or vacuum pressure-swing adsorption. Elimination of the CO₂ from the process gas results in the reduction gas which, before being introduced into the reduction unit, is heated in the reduction gas heating device to a temperature of 700 to 1200° C., which is suitable for performing the reduction of the metal oxides.

The dedusted and/or cooled first partial amount of the top gas is used as the recycle gas, possibly after the compression. The first partial amount of the recycle gas is cooled in the recycle gas cooler to form the cold recycle gas and then added to the export gas. The second partial amount of the recycle gas is added to the export gas as hot recycle gas.

The advantage derived from this embodiment variant of the inventive method is that the thermal energy (so-called sensible heat) contained in the recycle gas is used to increase the temperature of the export gas. Therefore it is not necessary for the hot recycle gas to undergo further heating before it is added to the export gas.

In a further embodiment variant of the inventive method, the lower limit of the temperature of the hot recycle gas is 80° C., preferably 100° C., and the upper limit of the temperature of the hot recycle gas is 180° C., preferably 150° C.

If the temperature of the hot recycle gas lies in the specified temperature range, a corresponding hot recycle gas stream ensures that the temperature of the export gas mixture does not fall below the dew point temperature.

In a further embodiment variant of the inventive method, the export gas includes crucible gas from the gas network of a steelworks and/or comes from a plant for producing pig iron and/or a coal gasification plant and/or a coking plant.

A plant for producing pig iron is e.g. a COREX® plant, a FINEX® plant or an oxygen blast furnace, all of which are known from the prior art. The export gas can therefore also contain or consist of blast-furnace gas from the oxygen blast furnace. If the export gas comes from a coal gasification plant, it may be beneficial to use the pressure energy contained in the export gas in an expansion turbine. The Joule-Thompson effect which occurs when using the pressure energy in the expansion turbine results in a cooling of the export gas. The inventive addition of the hot recycle gas to the export gas balances out the cooling of the export gas and ensures sufficiently high superheating of the export gas.

In a preferred embodiment variant of the inventive method, the export gas undergoes dust removal and/or gas purification in a device for dust removal and/or gas purification before being used in the reduction process, wherein the hot recycle gas and the cold recycle gas are added to the export gas before the dust removal and/or gas purification.

In the device for dust removal and/or gas purification, provision is made for separating out the dust particles or solid particles which are carried along with the export gas mixture.

The removal of dust from the export gas ensures that subsequent components are protected against increased wear or damage caused by dust particles or solid particles carried along with the export gas.

By virtue of adding the hot recycle gas and the cold recycle gas to the export gas before the dust removal and/or gas purification, the export gas containing hot recycle gas is already in a superheated state when it enters the device for dust removal and/or gas purification. This prevents any occurrence of damp operation or wet/dry transitions in this device, and any accumulation of residues in this device due to condensation/sublimation of polyaromatic hydrocarbons which may be present in the export gas.

If the cold recycle gas and the hot recycle gas are added to the export gas as a mixture, the addition of the mixture takes place before the dust removal and/or gas purification of the export gas.

A preferred embodiment variant of the inventive method is characterized in that the temperature of the export gas mixture is at most 50° C., and preferably between 2° C. and 15° C., higher than the temperature of the export gas before the addition of the cold recycle gas and the hot recycle gas.

This ensures that, before compression in the export gas compressor, the export gas mixture is superheated by the addition of the hot recycle gas to the extent that a sufficiently high safety margin exists in relation to the dew point of the export gas mixture.

In a particularly preferred embodiment variant of the inventive method, the temperature of the export gas mixture is regulated to a specific value by the amount of the hot recycle gas which is added to the export gas mixture.

The temperature of the export gas mixture is preferably so regulated as to essentially exceed the dew point temperature of the export gas mixture by a constant value. It is thereby ensured that the dew point of the export gas mixture is exceeded in a constant manner during all operating states of the inventive method.

Further subject matter of the invention relates to a device for performing the inventive method, comprising:
an export gas line for introducing an export gas mixture into a reduction process,
a recycle gas line with a first pressure regulating device and/or first amount regulating device, which preferably takes the form of a recycle gas compressor, in the recycle gas line, and
a cold recycle gas line which emerges from the recycle gas line, with a recycle gas cooler that is arranged in the cold recycle gas line,
   wherein

provision is made for a hot recycle gas line which emerges from the recycle gas line and has a second pressure regulating device and/or second amount regulating device that is arranged in the hot recycle gas line, and wherein the cold recycle gas line and the hot recycle gas line flow into the export gas line, or the cold recycle gas line and the hot recycle gas line are combined in a return line which flows into the export gas line.

The export gas or the export gas mixture is introduced into the reduction process by means of the export gas line. In this case, the reduction process comprises e.g. the preparation of the export gas mixture to form the reduction gas, which is then supplied to the reduction unit for reduction of the metal oxides. A recycle gas compressor is preferably arranged in the recycle gas line. After the recycle gas compressor, the cold recycle gas line and the hot recycle gas line emerge from recycle gas line, and both flow into the export gas line or the return line. If the return line is present, it flows into the export gas line. A recycle gas cooler is arranged in the cold recycle gas line. The second pressure regulating device and/or the second amount regulating device is arranged in the hot recycle gas line, preferably taking the form of a position-regulated valve, in particular a hand indicator control or control valve with position indication. Such a valve may also be arranged in the cold recycle gas line.

By virtue of the inventive device features, the export gas can be superheated by means of adding the hot recycle gas. The effect of this superheating is to prevent water droplets from forming as a result of falling below the dew point of the export gas containing the hot recycle gas, i.e. the export gas mixture, and therefore to prevent, in consideration of dust particles which are present in the export gas, any accumulation of residues, e.g. at inlet guides and impellers of the export gas compressor that is present in the reduction process, as a result of wet/dry transitions or condensation/sublimation of the polyaromatic hydrocarbons which may be present in the export gas.

The danger of stress crack corrosion at the impellers of the export gas compressor is also minimized by the measures according to the invention.

A preferred embodiment variant of the inventive device is characterized in that it further comprises:
a reduction gas line which flows into a reduction unit for the supply of reduction gas into the reduction unit,
a top gas line which emerges from the reduction unit, an apparatus being arranged in said top gas line for the purpose of dust removal and/or cooling of top gas, wherein the recycle gas line branches off the top gas line after the apparatus for dust removal and/or cooling, and wherein the cold recycle gas line and the hot recycle gas line emerge from the recycle gas line after the first pressure regulating device and/or the first amount regulating device,
at least one export gas compressor which is arranged in the export gas line,
a CO₂ eliminating device which is arranged downstream of the export gas compressor, and
a reduction gas heating device which is arranged downstream of the CO₂ eliminating device.

The reduction gas line, by means of which the reduction gas is introduced into the reduction unit, flows into the reduction unit. The reduction gas, which is at least partially used in the reduction unit during the reduction of the metal oxides, is withdrawn from the reduction unit via the top gas line. An apparatus for dust removal and/or cooling of the top gas is arranged in the top gas line. The recycle gas line branches off from the top gas line after the apparatus for dust removal and/or cooling of the top gas. The recycle gas compressor is preferably arranged in the recycle gas line. The first partial amount of the top gas is supplied to the recycle gas compressor by means of the recycle gas line.

The device further comprises the export gas line in which the at least one export gas compressor is arranged. The export gas mixture is compressed in the export gas compressor to form the process gas. The CO₂ eliminating device, for eliminating the CO₂ from the process gas while obtaining the reduction gas, is arranged in the export gas line and downstream of the export gas compressor. The CO₂ eliminating device is preferably a PSA or VPSA system. The reduction gas heating device for heating the reduction gas is arranged downstream of the CO₂ eliminating device. A process gas cooler is optionally situated in the export gas line between the export gas compressor and the reduction gas heating device.

The advantage derived from this embodiment variant of the inventive device is that the thermal energy (so-called sensible heat) contained in the recycle gas can be used to increase the temperature of the export gas. Therefore it is not necessary for the hot recycle gas to undergo further heating before it is added to the export gas.

In a further embodiment variant of the inventive device, the export gas line emerges from a gas network of a steelworks and/or from a plant for producing pig iron and/or from a coal gasification plant and/or from a coking plant.

A plant for producing pig iron is e.g. a COREX® plant, a FINEX® plant or an oxygen blast furnace, all of which are known from the prior art.

An embodiment variant of the inventive device is designed such that a device for dust removal and/or gas purification is arranged in the export gas line, wherein the hot recycle gas line and the cold recycle gas line or the return line flow into the export gas line before the device for dust removal and/or gas purification.

The device for dust removal and/or gas purification is preferably a dry dust removal device which is based on filter bags or filter cartridges.

The hot recycle gas line and the cold recycle gas line flow into the export gas line before the device for dust removal and/or gas purification. In a preferred variant of the inventive device, the return line flows into the export gas line before the device for dust removal and/or gas purification. In this context, the expressions before and after are to be interpreted in relation to the gas flow direction of the export gas.

The dedusting of the export gas by means of the device for dust removal and/or gas purification ensures that subsequent components such as e.g. the export gas compressor, the process gas cooler, the CO₂ eliminating device and the reduction gas heating device, are protected against damage by solid components such as e.g. dust particles which are carried along with the export gas.

By virtue of adding the hot recycle gas to the export gas before the latter is dedusted in the device for dust removal and/or gas purification, the export gas containing the hot recycle gas is already in a superheated state when it enters the device for dust removal and/or gas purification. This prevents any occurrence of wet/dry transitions in the device for dust removal and/or gas purification, and any accumulation of residues in the device for dust removal and/or gas purification due to condensation/sublimation of polyaromatic hydrocarbons which may be present in the export gas.

### BRIEF DESCRIPTION OF THE DRAWINGS

The invention is explained in greater detail below with reference to exemplary and schematic figures, in which:

FIG. 1 shows a schematic example of a method according to the invention and a device according to the invention,

FIG. 2 shows a schematic example of a specific embodiment variant of the inventive method and the inventive device,

FIG. 3 shows a schematic example of a further specific embodiment variant of the inventive method and the inventive device, and

FIG. 4 shows a schematic example of a method according to the invention and a device according to the invention, with a reduction unit for the reduction of metal oxides.

### DESCRIPTION

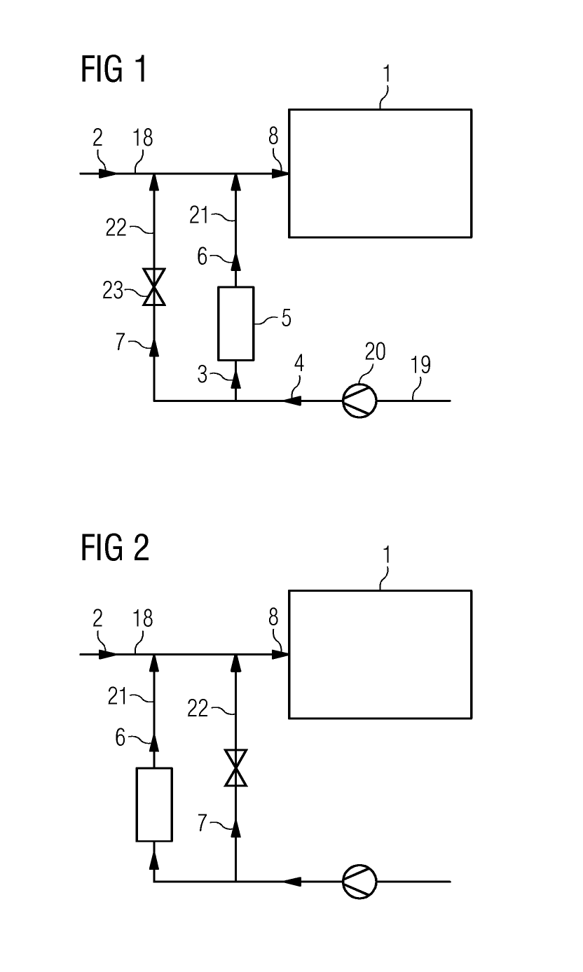

FIG. 1 shows a schematic example of a method according to the invention and a device according to the invention, wherein cooling of a first partial amount 3 of a recycle gas 4 which preferably has essentially the same composition as the export gas 2 is effected in at least one recycle gas cooler 5, thereby forming a cold recycle gas 6, in order to balance out amount fluctuations while simultaneously increasing the temperature of an export gas 2 which is used in a reduction process 1. The cold recycle gas 6 is added to the export gas 2 by means of a cold recycle gas line 21 in a pressure-controlled and/or amount-controlled manner in order to balance out amount fluctuations of the export gas 2. The cold recycle gas 6 has essentially the same temperature as the export gas 2. In addition, a second partial amount of the recycle gas 4 is added to the export gas 2 by means of a hot recycle gas line 22 in a pressure-controlled and/or amount-controlled manner as a hot recycle gas 7 having a higher temperature than the cold recycle gas 6. In this case, the cold recycle gas line 21 and the hot recycle gas line 22 emerge from a recycle gas line 19, in which a first pressure regulating device and/or a first amount regulating device 20 is arranged. The first pressure regulating device and/or the first amount regulating device 20 is preferably a recycle gas compressor. The export gas 2 now includes the hot recycle gas 7 and the cold recycle gas 6 and is introduced into the reduction process 1 as an export gas mixture 8 by means of an export gas line 18. The temperature of the export gas mixture 8 is higher than the temperature of the export gas 2. The pressure regulation and/or the amount regulation of the cold recycle gas 6 is effected by means of the first pressure regulating device and/or the first amount regulating device 20. The pressure regulation and/or the amount regulation of the hot recycle gas 7 is effected by means of a second pressure regulating device and/or a second amount regulating device 23, which is arranged in the hot recycle gas line 22. The arrows in FIG. 1 indicate the flow directions of the corresponding gases. In the embodiment variant described in FIG. 1, the hot recycle gas line 22 flows into the export gas line 18 before the cold recycle gas line 21, viewed in the gas flow direction of the export gas 2. The hot recycle gas 7 is added to the export gas 2 first, then the cold recycle gas 6 is added to the export gas 2 containing the hot recycle gas 7, after which the export gas mixture 8 containing the hot recycle gas 7 and the cold recycle gas 6 is used in the reduction process 1.

FIG. 2 shows a schematic example of a specific embodiment variant of the inventive method and the inventive device. As in FIG. 1, the arrows likewise indicate the flow directions of the corresponding gases here. The difference over the method illustrated in FIG. 1 is that the hot recycle gas line 22 flows into the export gas line 18 after the cold recycle gas line 21, viewed in the gas flow direction of the export gas 2. The cold recycle gas 6 is added to the export gas 2 first, then the hot recycle gas 7 is added to the export gas 2 containing the cold recycle gas 6, after which the export gas mixture 8 containing the hot recycle gas 7 and the cold recycle gas 6 is used in the reduction process 1.

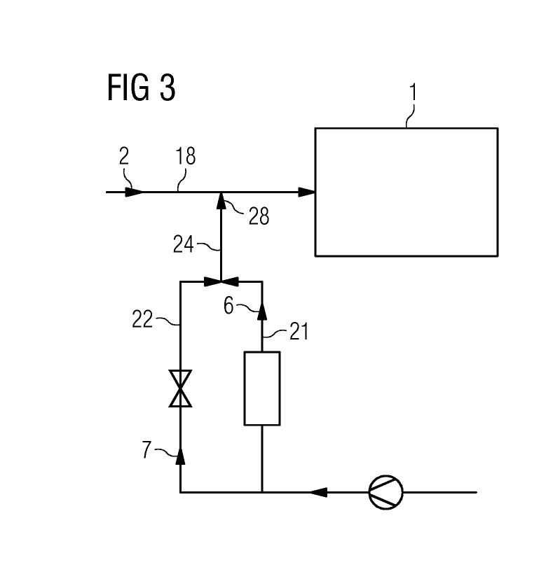

FIG. 3 shows a schematic example of a further specific embodiment variant of the inventive method and the inventive device. The difference over the methods illustrated in FIG. 1 and FIG. 2 is that the cold recycle gas 6 and the hot recycle gas 7 are mixed to form a mixture 28 before being added to the export gas 2. The mixture 28 is subsequently added to the export gas 2. In this case, the cold recycle gas line 21 and the hot recycle gas line 22 are combined in a return line 24 which flows into the export gas line 18. After the addition of the mixture 28 to the export gas 2, the export gas 2 contains both the cold recycle gas 6 and the hot recycle gas 7.

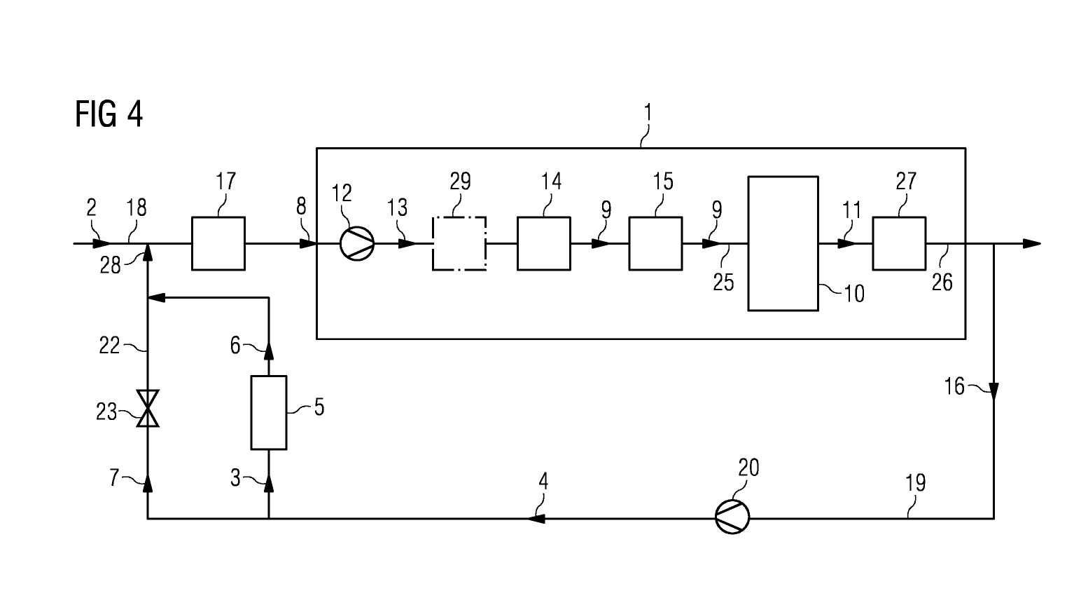

FIG. 4 shows a schematic example of a method according to the invention and a device according to the invention, with a reduction unit 10 for the reduction of metal oxides. In this case, the reduction gas 9 which has been obtained from the export gas mixture 8 is introduced by means of a reduction gas line 25 into the reduction unit 10 for the reduction of metal oxides. After at least partial conversion during the reduction of the metal oxides, the reduction gas 9 is withdrawn from the reduction unit 10 as top gas 11 by means of a top gas line 26. The reduction gas 9 is obtained by compression of the export gas mixture 8, which has been introduced into the reduction process 1 via the export gas line 18, in at least one export gas compressor 12 to form a process gas 13. The process gas 13 optionally undergoes cooling in a process gas cooler 29 before being introduced into a CO₂ eliminating device 14 in order to obtain the reduction gas 9. Heating of the reduction gas 9 then takes place in a reduction gas heating device 15. A first partial amount 16 of the top gas 11, which has been dedusted and/or cooled in an apparatus 27 for dust removal and/or cooling of top gas 11, is supplied by means of the recycle gas line 19 to the first pressure regulating device and/or first amount regulating device 20, this being embodied as a recycle gas compressor, and is compressed therein to form the recycle gas 4. The cooling of the first partial amount 3 of the recycle gas 4 then takes place in the recycle gas cooler 5 to form the cold recycle gas 6. The cold recycle gas 6 and the hot recycle gas 7 are together added as a mixture 28 to the export gas 2 by means of a return line 24 in which the cold recycle gas line 21 and the hot recycle gas line 22 are combined. The pressure regulation and/or amount regulation of the hot recycle gas 7 is effected by means of the second pressure regulating device and/or the second amount regulating device 23.

The export gas 2 undergoes dust removal and/or gas purification in a device 17 for dust removal and/or gas purification before it is used in the reduction process 1. The arrows in FIG. 4 indicate the flow directions of the corresponding gases. Both the hot recycle gas 7 and the cold recycle gas 6 are added to the export gas 2 before the device 17 for dust removal and/or gas purification.

As a result, the temperature of the export gas mixture 8 is higher than the temperature of the export gas 2 before the addition of the cold recycle gas 6 and the hot recycle gas 7. As a result of adding the hot recycle gas 7 to the export gas 2, the sensible energy of the hot recycle gas 7 is used to increase the temperature of the export gas 2. The temperature of the export gas 2 or of the export gas mixture 8 is therefore so adjusted as to be higher than its dew point or its dew point temperature. This operation is known as superheating of the export gas 2 or the export gas mixture 8. One advantageous effect of this superheating is to avoid wet/dry transitions due to condensation/evaporation of water as a result of falling below the dew point of the export gas mixture 8, and to prevent an accumulation of residues at inlet guides and/or impellers of the export gas compressor 12 due to condensation/sublimation of polyaromatic hydrocarbons in connection with dust particles which may be present in the export gas 2 or in the export gas mixture 8 and/or in the recycle gas 4. The measures according to the invention also minimize the danger of stress crack corrosion at the impellers of the export gas compressor 12.

Although the invention is illustrated and described in detail with reference to the preferred exemplary embodiments, the invention is not restricted to the example disclosed herein, and other variations may be derived therefrom by a person skilled in the art without thereby departing from the scope of the invention.

### LIST OF REFERENCE SIGNS

1 Reduction process

2 Export gas

3 First partial amount of the recycle gas

4 Recycle gas

5 Recycle gas cooler

6 Cold recycle gas

7 Hot recycle gas

8 Export gas mixture

9 Reduction gas

10 Reduction unit

11 Top gas

12 Export gas compressor

13 Process gas

14 CO₂ eliminating device

15 Reduction gas heating device

16 First partial amount of the top gas

17 Device for dust removal and/or gas purification

18 Export gas line

19 Recycle gas line

20 First pressure regulating device and/or first amount regulating device

21 Cold recycle gas line

22 Hot recycle gas line

23 Second pressure regulating device and/or second amount regulating device

24 Return line

25 Reduction gas line

26 Top gas line

27 Apparatus for dust removal and/or cooling of top gas

28 Mixture

29 Process gas cooler

1. A method for balancing out amount fluctuations while simultaneously increasing the temperature of an export gas used in a reduction process, the method comprising steps of:
cooling a first partial amount of a recycle gas in at least one recycle gas cooler to form a cold recycle gas;
adding the cold recycle gas to the export gas in at least one of a pressure-controlled and an amount-controlled manner in order to balance out amount fluctuations of the export gas;
adding a second partial amount of the recycle gas to the export gas in at least one of a pressure-controlled manner and an amount-controlled manner as a hot recycle gas having a higher temperature than the cold recycle gas; and
then introducing an export gas mixture comprising the cold recycle gas and the hot recycle gas into the reduction process, wherein the temperature of the export gas mixture is higher than the temperature of the export gas.

2. The method as claimed in claim 1, wherein the cold recycle gas has essentially the same temperature as the export gas.

3. The method as claimed in claim 1, further comprising introducing a reduction gas obtained from the export gas mixture into a reduction unit for the reduction of metal oxides, withdrawing the reduction gas from the reduction unit as a top gas after at least partial reduction of the metal oxides, wherein the reduction gas is obtained by the method steps:
compressing the export gas mixture in at least one export gas compressor to form a process gas;
optionally cooling the process gas in a process gas cooler and eliminating CO₂ and/or H₂O from the process gas in a CO₂ eliminating device while obtaining the reduction gas, and
heating the reduction gas in a reduction gas heating device;
wherein a first partial amount of the top gas, is used as the recycle gas.

4. The method as claimed in claim 1, further comprising the lower limit of the temperature of the hot recycle gas is 80° C. and the upper limit of the temperature of the hot recycle gas is 180° C.

5. The method as claimed in claim 1, wherein the export gas comprises crucible gas from at least one of a gas network of a steelworks, a plant for producing pig iron, a coal gasification plant and a coking plant.

6. The method as claimed in claim 1, further comprising at least one of dust removal and gas purification in a respective device for at least one of dust removal and gas purification before use in the reduction process, and the method further comprising:
adding the hot recycle gas and the cold recycle gas to the export gas before the at least one of the dust removal and the gas purification.

7. The method as claimed in claim 4, further comprising causing the temperature of the export gas mixture to be at most 50° C., higher than the temperature of the export gas before the addition of the cold recycle gas and the hot recycle gas.

8. The method as claimed in claim 1, further comprising regenerating the temperature of the export gas mixture to a specific value by regulating the amount of the hot recycle gas which is added to the export gas mixture.

9. A device for performing the method as claimed in claim 1, wherein the device comprises:
an export gas line for introducing an export gas mixture into a reduction process;
a recycle gas line and at least one of a first pressure regulating device and a first amount regulating device in the recycle gas line;
a cold recycle gas line which emerges from the recycle gas line and a recycle gas cooler in the cold recycle gas line;
a hot recycle gas line which emerges from the recycle gas line;
at least one of a second pressure regulating device and a second amount regulating device in the hot recycle gas line;
wherein the cold recycle gas line and the hot recycle gas line flow into the export gas line, or the cold recycle gas line and the hot recycle gas line are combined in a return line which flows into the export gas line.

10. The device as claimed in claim 9, further comprising:
a reduction gas line which flows into a reduction unit for the supply of reduction gas into the reduction unit;
a top gas line which emerges from the reduction unit, an apparatus in the top gas line configured for the purpose of at least one of dust removal and cooling of top gas, wherein the recycle gas line branches off the top gas line after the apparatus respectively for at least one of the dust removal and the cooling; and
wherein the cold recycle gas line and the hot recycle gas line emerge from the recycle gas line at a location after at least one of the first pressure regulating device and the first amount regulating device;
at least one export gas compressor which is arranged in the export gas line;
a CO₂ eliminating device downstream in a direction of gas flow of the export gas compressor; and
a reduction gas heating device downstream of the CO₂ eliminating device and from which the reduction gas line emerges.

11. The device as claimed in claim 9, further comprising the export gas line emerging from at least one of a gas network of a steelworks, a plant for producing pig iron, a coal gasification plant and a coking plant.

12. The device as claimed in claim 9, further comprising a device for at least one of dust removal and gas purification in the export gas line, wherein the hot recycle gas line, the cold recycle gas line or the return line flow into the export gas line at a location before the device for at least one of dust removal and gas purification.

13. The method as claimed in claim 3, further comprising at least one of dedusting and cooling the first partial amount of the top gas, and then using the first partial amount of the top gas as the recycle gas.

14. The method as claimed in claim 13, further comprising compressing the first partial amount of the top gas after the dedusting.

15. The method as claimed in claim 1, further comprising the lower limit of the temperature of the hot recycle gas is 100° C., and the upper limit of the temperature of the hot recycle gas is 150° C.

16. The method as claimed in claim 9, wherein the regulating device is in a form of a recycle gas compressor.

17. The method as claimed in claim 1, further comprising causing the temperature of the export gas mixture to be between 2° C. and 15° C., higher than the temperature of the export gas before the addition of the cold recycle gas and the hot recycle gas.
